(19) United States
(12) Patent Application Publication
(10) Pub. No.: US 2026/0081053 A1
(43) Pub. Date: Mar. 19, 2026

(54) CABLE ASSEMBLY

(71) Applicant: SAMSUNG ELECTRONICS CO., LTD., Suwon-si (KR)

(72) Inventors: Seungwoo JUNG, Suwon-si (KR); Baekseok KO, Suwon-si (KR); Hyunjin OH, Suwon-si (KR)

(73) Assignee: SAMSUNG ELECTRONICS CO., LTD., Suwon-si (KR)

(21) Appl. No.: 19/209,046

(22) Filed: May 15, 2025

Related U.S. Application Data
(63) Continuation of application No. PCT/KR2025/005623, filed on Apr. 25, 2025.

(30) Foreign Application Priority Data
Sep. 13, 2024 (KR) 10-2024-0125972

(51) Int. Cl. H01B 11/10

(52) U.S. Cl. CPC H01B 11/1091

(57) ABSTRACT

A cable assembly including a cable including a plurality of conductors, and a shielding member to shield the plurality of conductors, and including a plurality of ground wires connectable to a ground electrode; and a connector including a connecting member through which an end of the cable passes, wherein the cable is configured so that ground wires of the plurality of ground wires in an end area of the cable in the connecting member cross between conductors of the plurality of conductors.

### CROSS-REFERENCE TO RELATED APPLICATIONS

This application is a continuation application of International Application No. PCT/KR2025/005623 designating the United States, filed on Apr. 25, 2025, in the Korean Intellectual Property Receiving Office, which claims priority from Korean Patent Application No. 10-2024-0125972, filed on Sep. 13, 2024, in the Korean Intellectual Property Office, the disclosures of which are hereby incorporated by reference herein in their entireties.

### BACKGROUND

### Field

Various embodiments of the disclosure relate to a cable assembly and, more particularly, to a cable assembly having a structure for filtering electromagnetic interference (EMI) noise generated at a portion where a cable and a connector are connected.

### Description of Related Art

Electromagnetic interference (EMI) is a failure in which electromagnetic signals are affected by electromagnetic interference, and causes many problems as technologies using electromagnetic waves increase. Recent electronic products are required to have electromagnetic shielding structures.

A cable may include a conductor such as a copper wire for transmission of high-voltage power. The cable may have an electromagnetic wave shielding structure that surrounds the conductor to shield against electromagnetic waves.

In cable assemblies, EMI noise may occur where the cable and the connector are connected or joined.

The above-described information may be provided as related art for the purpose of helping understanding of the disclosure. No claim or determination is made as to whether any of the foregoing is applicable as background art in relation to the disclosure.

### SUMMARY

Aspects of embodiments of the disclosure will be set forth in part in the description which follows and, in part, will be apparent from the description, or may be learned by practice of the presented embodiments.

According to an embodiment of the disclosure, a cable assembly includes a cable including a plurality of conductors, and a shielding member to shield the plurality of conductors, and including a plurality of ground wires connectable to a ground electrode; and a connector including a connecting member through which an end of the cable passes, wherein the cable is configured so that ground wires of the plurality of ground wires in an end area of the cable in the connecting member cross between conductors of the plurality of conductors.

According to an embodiment of the disclosure, a length of the shielding member in the connecting member may be branched into a plurality of shielding lines. Each shielding line of the plurality of shielding lines may cross between the conductors of the plurality of conductors.

According to an embodiment of the disclosure, each shielding line of the plurality of shielding lines may include at least one ground wire of the plurality of ground wires.

According to an embodiment of the disclosure, free ends of the ground wires of the plurality of ground wires may be positioned to contact an outer circumferential surface of the cable.

According to an embodiment of the disclosure, the free ends of the ground wires of the plurality of ground wires may be bonded to the outer circumferential surface of the cable by compression.

According to an embodiment of the disclosure, in the connecting member, a first ground wire of the plurality of ground wires may cross at least a second ground wire of the plurality of ground wires.

According to an embodiment of the disclosure, the plurality of ground wires may form a net or mesh in the connecting member.

According to an embodiment of the disclosure, the plurality of ground wires may form a plurality of layered nets or meshes in the connecting member.

According to an embodiment of the disclosure, each conductor of the plurality of conductors may penetrate a hole of the mesh or the net formed by the plurality of ground wires.

According to an embodiment of the disclosure, in the connecting member, the plurality of ground wires may separate adjacent conductors of the plurality of conductors.

According to an embodiment of the disclosure, the plurality of ground wires may extend to separate and shield the conductors of the plurality of conductors in the connecting member.

According to an embodiment of the disclosure, the cable may be a high-definition multimedia interface (HDMI) cable. The connector may be an HDMI connector.

According to an embodiment of the disclosure, the plurality of ground wires may surround each conductor of the plurality of conductors in the connecting member.

According to an embodiment of the disclosure, the cable may include a sheath surrounding the shielding member.

According to an embodiment of the disclosure, the shielding member may be a braided shield or a spiral shield.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

These and/or other aspects of the disclosure will become apparent and more readily appreciated from the following description of embodiments, taken in conjunction with the accompanying drawings listed below.

FIG. 1 is a perspective view illustrating a cable assembly installed in a display device according to an embodiment.

FIG. 2 is a perspective view illustrating a cable assembly according to an embodiment.

FIG. 3 is a cross-sectional view illustrating a cable of a cable assembly according to an embodiment.

FIG. 4 is an exploded perspective view illustrating a cable assembly according to an embodiment.

FIG. 5 is an example view illustrating EMI noise generated at a portion where a connector and a cable are connected.

FIG. 6 is a view illustrating a state before a cable and a connector are coupled in a cable assembly according to an embodiment.

FIG. 7 is a cross-sectional view illustrating a cable end positioned in a connecting member in a cable assembly according to an embodiment.

FIG. 8 is a view illustrating a cable end positioned in a connecting member in a cable assembly according to an embodiment.

FIG. 9 is a perspective view schematically illustrating a portion where a cable and a connector are connected in a cable assembly including a connector coupled in a straight line arrangement according to an embodiment.

FIG. 10 is a side view illustrating the cable assembly of FIG. 9.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

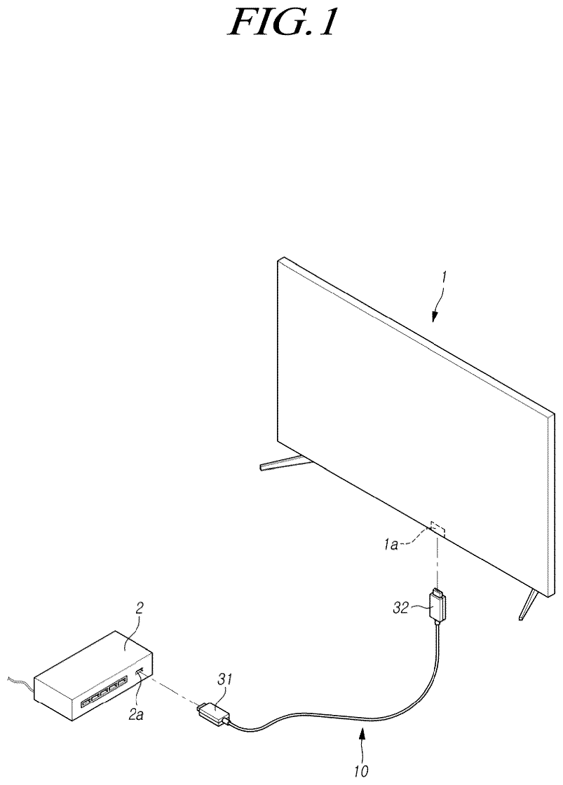

Various embodiments of the disclosure are merely exemplified herein with reference to FIGS. 1 to 10, to describe the principle of the disclosure, and should not be interpreted as limiting the scope of the disclosure. Those skilled in the art will understand that the principle of the disclosure may be implemented in any appropriately disposed system or device.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

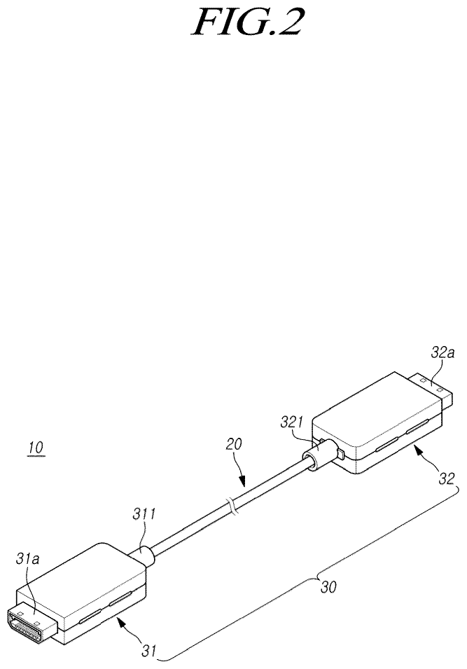

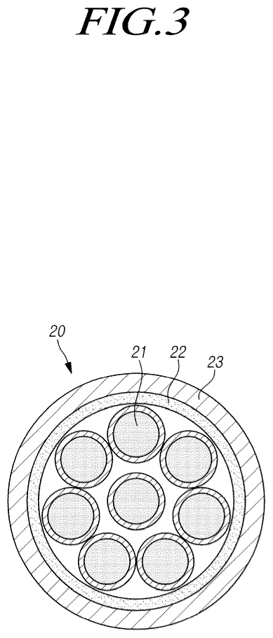

FIG. 1 is a perspective view illustrating a cable assembly installed in a display device according to an embodiment. FIG. 2 is a perspective view illustrating a cable assembly according to an embodiment. FIG. 3 is a cross-sectional view illustrating a cable of a cable assembly according to an embodiment.

Referring to FIGS. 1 to 3, the display device 1 may be connected to the source device 2 through the cable assembly 10.

According to an embodiment, the display device 1 may be provided to display an image. The display device 1 may include a port 1a. The port 1a may be formed for physical and/or electrical connection with the cable assembly 10.

According to an embodiment, the source device 2 may receive data from various sources. The source device 2 may be provided to transmit the received data to the display device 1. The source device 2 may include a port 2a. The port 2a may be formed for physical and/or electrical connection with the cable assembly 10.

According to an embodiment, the cable assembly 10 may include a cable 20 and a connector 30. The cable assembly 10 may be disposed to physically and/or electrically connect the display device 1 and the source device 2.

According to an embodiment, the connector 30 may be disposed such that each end of the cable 20 is connected to a respective connector 30. The connector 30 may be connected to the display device 1 or the source device 2. The cable assembly 10 may receive data from the source device 2 through the connector 30 and transmit the received data to the display device 1 through the connector 30.

According to an embodiment, the connector 30 may include a first connector 31 and a second connector 32. The first connector 31 may be connected to one of the display device 1 and the source device 2, for example. The second connector 32 may be connected to the other one of the display device 1 or the source device 2, for example. The first connector 31 and the second connector 32 may be configured to be substantially the same or similar.

According to an embodiment, the first connector 31 may include a first plug 31a configured to be coupled to the port 1a or 2a of the display device 1 or the source device 2.

According to an embodiment, the second connector 32 may include a second plug 32a configured to be coupled to the port 1a or 2a of the display device 1 or the source device 2.

According to an embodiment, the cable 20 may be disposed to connect the first connector 31 and the second connector 32. The cable 20 may be disposed to interconnect the first connector 31 and the second connector 32. One end of the cable 20 may be coupled to the first connector 31. The other end of the cable 20 may be coupled to the second connector 32.

According to an embodiment, the connector 30 may include connecting members 311 and 321. The connecting members 311 and 321 may be formed to receive an end portion of the cable 20. For example, the cable 20 may pass through the connecting members 311 and 321 to be electrically connected to the connector 30. For example, the cable 20 may be electrically connected to the connector 30 in the connecting members 311 and 321.

According to an embodiment, the connecting members 311 and 321 may include an insulating material. The connecting members 311 and 321 may include a rubber or plastic material. The connecting members 311 and 321 may be disposed to connect the cable 20 and the connector 30. The connecting members 311 and 321 may be provided so that the cable 20 connected to the connector 30 may move to a predetermined degree. The connecting members 311 and 321 may be formed of a flexible material including PVC, PC, or plastic.

According to an embodiment, the connecting members 311 and 321 may be a portion of the connector 30, but are not limited thereto, and may be coupled to the connector 30 as a separate component.

According to an embodiment, the cable 20 may include a sheath 23, a shielding member 22, and a plurality of conductors 21. A filler may be disposed between the shielding member 22 and the plurality of conductors 21.

According to an embodiment, the plurality of conductors 21 may be disposed to electrically connect the first connector 31 and the second connector 32. The conductor 21 may be referred to as an electric wire or a core wire. The conductor 21 may include, e.g., a copper wire.

According to an embodiment, the shielding member 22 may be disposed to shield the plurality of conductors 21. For example, the shielding member 22 may be disposed to surround the plurality of conductors 21. The shielding member 22 may be disposed to be connected to the ground electrode. The shielding member 22 may surround the plurality of conductors 21 to shield the plurality of conductors 21. The shielding member 22 may be, e.g., a braided shield or a spiral shield, but the disclosure is not limited thereto.

According to an embodiment, the shielding member 22 may include a plurality of ground wires. The plurality of ground wires may be disposed to be connected to the ground electrode.

According to an embodiment, the cable 20 may further include a plurality of optical fibers. The plurality of optical fibers may be disposed to transmit an optical signal from the source device 2 to the display device 1. The plurality of optical fibers may be disposed inside the shielding member 22. The plurality of optical fibers serve as transmission media of optical signals and may be composed of a transparent core and a transparent cladding.

According to an embodiment, the sheath 23 may be positioned at the outermost side. The sheath 23 may be positioned outside the shielding member 22. The sheath 23 may be disposed to surround the shielding member 22. The sheath 23 may be formed to protect the plurality of conductors 21 disposed therein from an external environment. The sheath 23 may be formed of an insulating material. The sheath 23 may be integrally formed of a single material through an extrusion process. The sheath 23 may have a cylindrical shape as a whole.

According to an embodiment, the sheath 23 may be formed of a material through which light is transmitted. For example, the sheath 23 may include polyvinyl chloride (PVC).

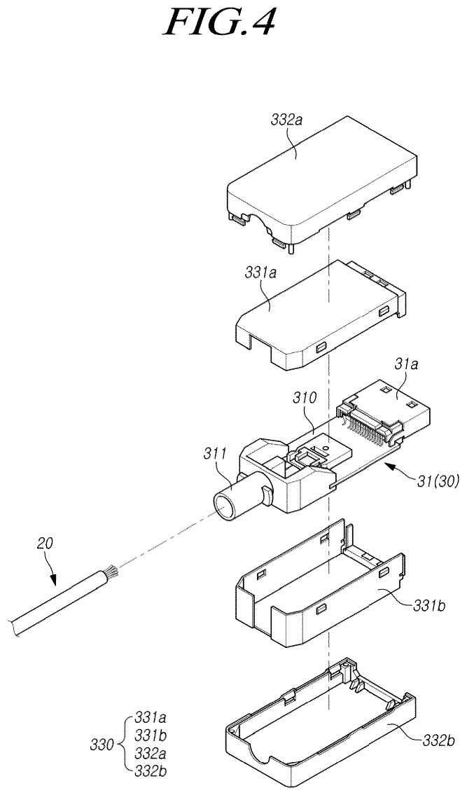

FIG. 4 is an exploded perspective view illustrating a cable assembly according to an embodiment.

FIG. 4 may be substantially identical or similar to the cable assembly of FIG. 2 (e.g., the cable assembly 10 of FIG. 2). FIG. 4 is an exploded perspective view illustrating one of the two connectors included in the cable assembly 10 of FIG. 2, but the other connector which is not illustrated may also have the same structure as that of FIG. 4.

The same reference numbers are used to denote substantially the same components as those described in connection with the cable assembly 10 of FIG. 2.

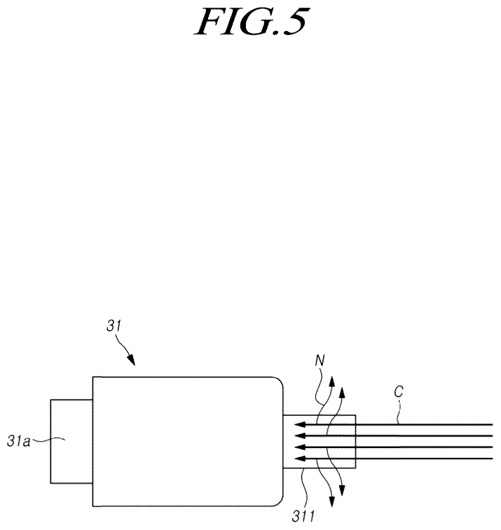

The embodiment of FIG. 4 may be selectively combined with the embodiments of FIGS. 1 to 3. The embodiment of FIG. 4 may be selectively combined with the embodiments of FIGS. 5 to 10.

Referring to FIG. 4, the cable assembly 10 may include a connector 30 and a cable 20. According to an embodiment, the connector 30 may include a printed circuit board 310, a plug 31a, and a case 330.

According to an embodiment, the printed circuit board 310 may be electrically connected to the cable 20. According to an embodiment, the printed circuit board 310 may include a ground electrode.

According to an embodiment, the plug 31a may be coupled to the printed circuit board 310. The plug 31a may be disposed to connect the external device and the connector 30.

According to an embodiment, the case 330 may be disposed to receive the printed circuit board 310. The case 330 may be disposed to protect the printed circuit board 310 from the outside.

According to an embodiment, the case 330 may include at least one of first cases 331a and 331b or second cases 332a and 332b. The case 330 may be referred to as a conductive case.

According to an embodiment, the first cases 331a and 331b may be formed of a conductive material. The first cases 331a and 331b may be provided in pair and may be disposed on an upper side and a lower side, respectively, of the printed circuit board 310. The pair of first cases 331a and 331b may be vertically coupled to each other. The first cases 331a and 331b may include, e.g., a metal material.

According to an embodiment, the second cases 332a and 332b may be formed of an insulating material. The second cases 332a and 332b may be disposed outside the first cases 331a and 331b. The second cases 332a and 332b may be disposed to surround the first cases 331a and 331b. The second cases 332a and 332b may be provided in pair and may be disposed on an upper side and a lower side, respectively, of the first cases 331a and 331b. The pair of second cases 332a and 332b may be vertically coupled to each other.

According to an embodiment, the second cases 332a and 332b may be disposed to contact the first cases 331a and 331b.

According to an embodiment, even when the second cases 332a and 332b are disposed to contact the first cases 331a and 33b having conductivity so that current flows through the first cases 331a and 33b, the current may not be transferred to the second cases 332a and 332b, which are insulators. Therefore, even when the user grips the second cases 332a and 332b, the user may not be electrocuted due to the current transmitted to the connector 30 through the cable 20.

FIG. 5 is an example view illustrating EMI noise generated at a portion where a connector and a cable are connected.

FIG. 5 is a schematic diagram for describing electromagnetic interference (EMI) noise generated at a connecting member, and the illustrated shape does not limit the scope of the disclosure.

Referring to FIG. 5, EMI noise may be generated at a portion where the cable 20 and the connector 30 are connected. When a high-speed signal C is transmitted through the conductor 21 disposed in the cable 20, EMI noise N may be radiated between the cable 20 and the connector 30. Problems such as generation of high-speed signal reflection signals due to dissatisfaction with a designed reflection coefficient value, and impedance unmatching between the cable 20 and the connector 30 may occur. These problems may appear as EMI noise (N) radiations.

As illustrated, the EMI noise N radiation may occur inside the connecting members 311 and 321. The EMI noise N radiation may occur inside the connecting members 311 and 321 which lacks a separate shielding structure. In the disclosure, a structure for attenuating such EMI noise N is proposed. The cable assembly according to an embodiment of the disclosure may address the EMI noise N radiation issue due to impedance unmatching inside the connecting members 311 and 321 without adding a separate shielding structure.

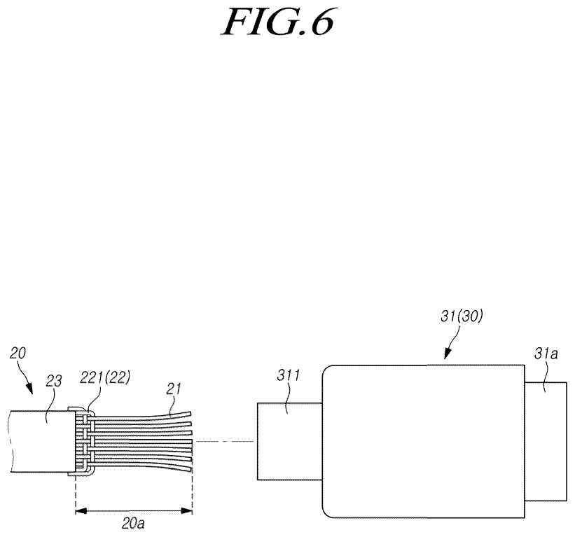

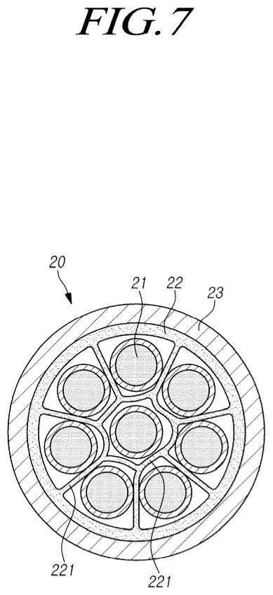

FIG. 6 is a view illustrating a state before a cable and a connector are coupled in a cable assembly according to an embodiment. FIG. 7 is a cross-sectional view illustrating a cable end positioned in a connecting member in a cable assembly according to an embodiment.

The components illustrated in FIGS. 6 and 7 may be included in the cable assembly 10 illustrated in FIGS. 1 to 4.

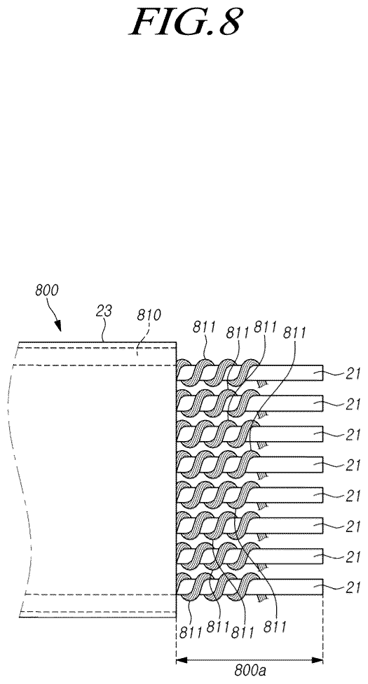

The embodiments of FIGS. 6 and 7 may be selectively combined with the embodiments of FIGS. 1 to 5. The embodiments of FIGS. 6 and 7 may be selectively combined with the embodiments of FIGS. 8 to 10.

The same reference numbers are used to denote substantially the same components as the above-described components among the components of FIGS. 6 and 7.

Referring to FIGS. 6 and 7, at the end portion of the cable 20, the plurality of conductors 21 may be exposed to the outside in order to be coupled to the connector 30. The sheath 23 of the end portion of the cable 20 may be removed so that the cable 20 contacts the connector 30.

According to an embodiment, the end area 20a of the cable 20 may be disposed in the connecting members 311 and 321. The end area 20a of the cable 20 may have the sheath 23 removed to be coupled to the connector 30. The shielding member 22 positioned in the end area 20a of the cable 20 may be branched into a shielding line 221 to be described below to serve to reduce EMI noise.

According to an embodiment, the shielding member 22 may be branched into several shielding lines 221 in the connecting members 311 and 321. In the end area 20a of the cable 20, only the sheath 23 is removed, and the shielding member 22 composed of a plurality of ground wires is not removed, and may be branched into the plurality of shielding lines 221. The number of the plurality of shielding lines 221 may vary.

According to an embodiment, each of the plurality of shielding lines 221 may be formed of at least one ground wire. The shielding line 221 may include a plurality of ground wires. The plurality of ground wires may be aggregated to form one shielding line 221. The number of ground wires included in each of the plurality of shielding lines 221 may vary.

According to an embodiment, in the end area 20a of the cable 20 positioned in the connecting members 311 and 321, the plurality of shielding lines 221 (or the plurality of ground wires) may be disposed to pass between the plurality of conductors. The plurality of shielding lines 221 (or the plurality of ground wires) may be disposed between the plurality of conductors 21. In the process of coupling the cable 20 and the connector 30, the operator may make a plurality of shielding lines 221 from the shielding member 22. The shielding line 221 made by the operator may be disposed in every space between two adjacent ones of the plurality of conductors 21. The shielding line 221 disposed between the plurality of conductors 21 may reduce EMI noise generated in the connecting members 311 and 321.

According to an embodiment, each of the plurality of shielding lines 221 may be disposed to cross between the plurality of conductors 21.

According to an embodiment, at least one of the plurality of shielding lines 221 may be disposed to cross the radius of the cable 20.

According to an embodiment, each of the plurality of shielding lines 221 may be disposed to have a curved shape.

According to an embodiment, one of the plurality of shielding lines 221 (or the plurality of ground wires) in the connecting members 311 and 321 may be disposed to cross at least one other shielding line among the plurality of shielding lines 221 (or the plurality of ground wires). The plurality of shielding lines 221 may cross different shielding lines 221 when disposed to pass between the plurality of conductors 21.

According to an embodiment, the plurality of shielding lines 221 (or the plurality of ground wires) may have a net shape or a mesh shape as a whole in the connecting members 311 and 321. For example, the plurality of shielding lines 221 (or the plurality of ground wires) may form a shape of several layered nets or meshes. Here, each of the plurality of conductors 21 may be disposed to penetrate the mesh hole of the net or mesh shape formed by the plurality of shielding lines 221 (or the plurality of ground wires).

According to an embodiment, the plurality of shielding lines 221 (or the plurality of ground wires) in the connecting members 311 and 321 may be disposed to separate adjacent conductors 21 among the plurality of conductors 21.

According to an embodiment, the plurality of shielding lines 221 (or the plurality of ground wires) may extend to serve to separate and shield between the plurality of conductors 21 in the connecting members 311 and 321.

In the cable assembly 10 of the disclosure, the plurality of shielding lines 221 are disposed in every space between the plurality of conductors 21 in the connecting members 311 and 321, achieving impedance matching between the connector 30 and the cable 20. As a result, EMI noise radiated from the connecting members 311 and 321 may be decreased.

According to an embodiment, the free ends of the plurality of shielding lines 221 (or the plurality of ground wires) may be positioned to contact the outer circumferential surface of the cable 20. The free end portion of the shielding line 221 remaining after crossing the plurality of conductors 21 may be bent to contact the outer circumferential surface of the cable 20 again.

According to an embodiment, the free ends of the plurality of shielding lines 221 (or the plurality of ground wires) may be bonded to the outer circumferential surface of the cable 20 by compression. In the process of connecting the cable 20 and the connector 30, the end portion of the cable 20 may be compressed by the coupling of the connecting members 311 and 321. By the compression of the connecting members 311 and 321, the free ends of the plurality of shielding lines 221 may be fixed in contact with the outer circumferential surface of the cable 20. The connecting members 311 and 321 may be disposed to fix the plurality of shielding lines 221.

According to an embodiment, the free ends of the plurality of shielding lines 221 (or the plurality of ground wires) may be inserted into the connector 30. For example, the free ends of the plurality of shielding lines 221 (or the plurality of ground wires) may be disposed between the first case (e.g., the first cases 331a and 331b of FIG. 4) and the second case (e.g., the second cases 332a and 332b of FIG. 4). Accordingly, it is possible to prevent the free ends of the plurality of shielding lines 221 (or the plurality of ground wires) from being exposed to the outside.

The cable 20 may be, e.g., a high-definition multimedia interface (HDMI) cable, but the disclosure is not limited thereto. The connector 30 may be, e.g., an HDMI connector, but the disclosure is not limited thereto.

According to an embodiment, EMI noise may be generated at the portion of the conductor 21 exposed to the outside by removing the sheath 23. In the disclosure, the magnitude of EMI noise may be decreased using the plurality of ground wires constituting the shielding member 22. In the disclosure, since the issue with the radiation in the connecting members 311 and 321 is addressed using the present shielding member 22, EMI noise may be decreased without adding a new component. Further, when the operator couples the cable 20 and the connector 30, it is not difficult to dispose the plurality of shielding lines 221 in every space between the plurality of conductors 21, making assembly easier.

FIG. 8 is a view illustrating a cable end positioned in a connecting member in a cable assembly according to an embodiment.

The configuration illustrated in FIG. 8 may be included in the cable assembly 10 illustrated in FIGS. 1 to 4.

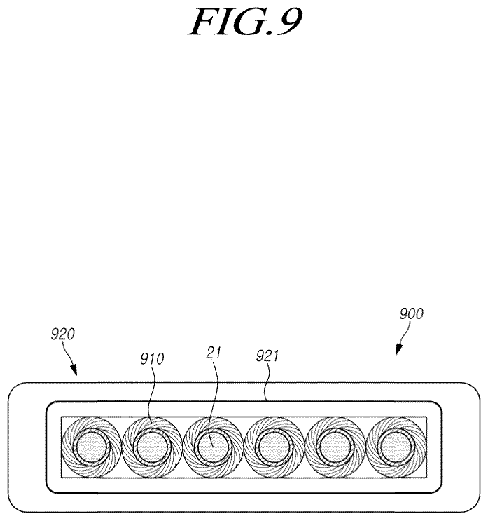

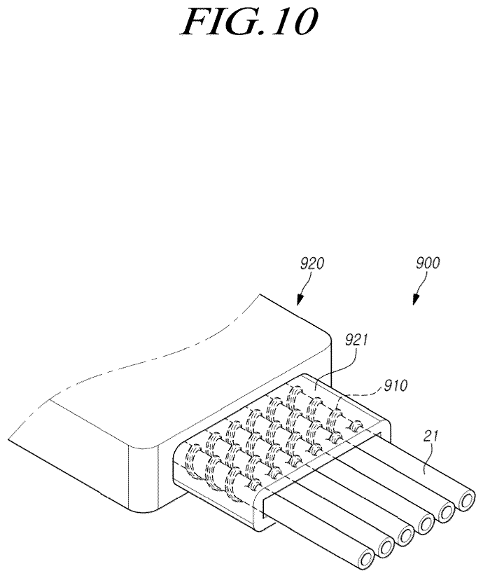

The embodiment of FIG. 8 may be selectively combined with the embodiment of FIGS. 1 to 7. The embodiments of FIG. 8 may be selectively combined with the embodiments of FIGS. 9 and 10.

The same reference numbers are used to denote substantially the same components as the above-described components among the components of FIG. 8.

Referring to FIG. 8, the cable 800 according to an embodiment may include a shielding member 810. The shielding member 810 may be disposed along an inner circumferential surface of the sheath 23. The shielding member 810 may include a plurality of ground wires.

According to an embodiment, the shielding member 810 may be disposed to surround the plurality of conductors 21. The shielding member 810 may be disposed to be connected to the ground electrode. The shielding member 810 may surround the plurality of conductors 21 to shield the plurality of conductors 21. The shielding member 810 may be, e.g., a braided shield or a spiral shield, but the disclosure is not limited thereto.

According to an embodiment, the shielding member 810 may include a plurality of ground wires. The plurality of ground wires may be disposed to be connected to the ground electrode.

According to an embodiment, the shielding member 810 may include a plurality of shielding lines 811. The plurality of shielding lines 811 may be disposed at an end portion of the shielding member 810. The plurality of shielding lines 811 may be disposed in the end area 800a of the cable 800.

According to an embodiment, the plurality of shielding lines 811 (or the plurality of ground wires) may be disposed to surround the circumference of each of the plurality of conductors 21 in the connecting member (e.g., the connecting members 311 and 321 of FIG. 2).

According to an embodiment, each of the plurality of shielding lines 811 (or the plurality of ground wires) may be disposed to surround one of the plurality of conductors 21. The shielding line 811 may be disposed to surround the outer circumferential surface of the conductor 21. For example, the shielding line 811 may be disposed to be wound around the conductor 21 one or more times. The shielding line 811 may be disposed to surround the conductor 21 in a spiral shape.

The shielding line 811 positioned in the connecting member (e.g., the connecting members 311 and 321 of FIG. 2) is disposed to surround the conductor 21, thereby reducing EMI noise radiated due to impedance unmatching between the connector (e.g., the connector 30 of FIG. 4) and the cable 800.

FIG. 9 is a perspective view schematically illustrating a portion where a cable and a connector are connected in a cable assembly including a connector coupled in a straight line arrangement according to an embodiment. FIG. 10 is a side view illustrating the cable assembly of FIG. 9.

The configurations illustrated in FIGS. 9 and 10 may be included in the cable assembly 10 illustrated in FIGS. 1 to 4.

The embodiments of FIGS. 9 and 10 may be selectively combined with the embodiments of FIGS. 1 to 8.

The same reference numbers are used to denote substantially the same components as the above-described components among the components of FIGS. 9 and 10.

Referring to FIGS. 9 and 10, a cable assembly 900 according to an embodiment may include a cable 20 and a connector 920.

In FIGS. 9 and 10, the cross section of the cable 20 for connecting to the connector 920 may be substantially the same as the cross section of the cable (e.g., the cable 20 of FIG. 3) illustrated in FIG. 3.

According to an embodiment, the cable (e.g., the cable 20 of FIG. 2) may include a plurality of conductors 21. The plurality of conductors 21 may be disposed to be electrically connected to the connector 920. The conductor 21 may be referred to as an electric wire or a core wire. The conductor 21 may include, e.g., a copper wire.

According to an embodiment, the cable 20 may include a plurality of shielding lines 910. The plurality of shielding lines 910 may extend from a shielding member (e.g., the shielding member 22 of FIG. 3) or may be included in the shielding member 22.

According to an embodiment, the shielding member 22 may be disposed to surround the plurality of conductors 21. The shielding member 22 may be disposed to be connected to the ground electrode. The shielding member 22 may surround the plurality of conductors 21 to shield the plurality of conductors 21. The shielding member 22 may be, e.g., a braided shield or a spiral shield, but the disclosure is not limited thereto.

According to an embodiment, the shielding member 22 may include a plurality of ground wires. The plurality of ground wires may be disposed to be connected to the ground electrode.

According to an embodiment, the shielding member 22 may include a plurality of shielding lines 910. The plurality of shielding lines 910 may be disposed at an end portion of the shielding member 22. The plurality of shielding lines 910 may be disposed in an end area of the cable 20.

According to an embodiment, the connector 920 may include a connecting member 921. When the plurality of conductors 21 are coupled to the connector 920, the conductors 21 may be coupled in a straight line arrangement as illustrated. The connecting member 921 may be disposed to cover the end portions of the conductors 21 coupled in a straight line.

According to an embodiment, the plurality of shielding lines 910 (or the plurality of ground wires) may be disposed to surround the circumference of each of the plurality of conductors 21 in the connecting member 921.

According to an embodiment, each of the plurality of shielding lines 910 (or the plurality of ground wires) may be disposed to surround one of the plurality of conductors 21. The shielding line 910 may be disposed to surround the outer circumferential surface of the conductor 21. For example, the shielding line 910 may be disposed to be wound around the conductor 21 one or more times. The shielding line 910 may be disposed to surround the conductor 21 in a spiral shape.

The shielding line 910 positioned in the connecting member 921 is disposed to surround the conductor 21, thereby reducing EMI noise radiated due to impedance unmatching between the connector 920 and the cable 20.

A cable assembly 10 according to an embodiment may comprise a cable 20, 800 including a plurality of conductors 21 and a shielding member 22, 810 disposed to shield the plurality of conductors 21 and including a plurality of ground wires connected to a ground electrode and a connector 30 including a connecting member 311, 321 formed to allow an end portion of the cable 20, 800 to pass therethrough. A portion of the plurality of ground wires, positioned in an end area 20a, 800a of the cable 20, 800, may be disposed to cross between the plurality of conductors 21.

According to an embodiment, the shielding member 22, 810 in the connecting member 311, 321 may be branched into a plurality of shielding lines 221, 811. Each of the shielding lines 221, 811 may be disposed to cross between the plurality of conductors 21.

According to an embodiment, each of the shielding lines 221, 811 may include at least one ground wire.

According to an embodiment, free ends of the plurality of ground wires may be positioned to contact an outer circumferential surface of the cable 20, 800.

According to an embodiment, free ends of the plurality of ground wires may be positioned to contact an outer circumferential surface of the cable 20, 800.

According to an embodiment, in the connecting member 311, 321, one of the plurality of ground wires may be disposed to cross at least one other ground wire among the plurality of ground cores.

According to an embodiment, the plurality of ground wires may overall form a net shape or mesh shape in the connecting member 311, 321.

According to an embodiment, the plurality of ground wires may form a shape of a plurality of layered nets or meshes in the connecting member 311, 321.

According to an embodiment, each of the plurality of conductors 21 may be disposed to penetrate a mesh hole of a mesh shape formed by the plurality of ground wires.

According to an embodiment, in the connecting member 311, 321, the plurality of ground wires may be disposed to separate adjacent conductors 21 among the plurality of conductors 21.

According to an embodiment, the plurality of ground wires may extend to separate and shield the plurality of conductors 21 in the connecting member 311, 321.

According to an embodiment, the cable 20, 800 may be a high-definition multimedia interface (HDMI) cable, and the connector 30 may be an HDMI connector.

According to an embodiment, the plurality of ground wires may be disposed to surround each of the plurality of conductors in the connecting member 311, 321.

According to an embodiment, the cable 20, 800 may further include a sheath disposed to surround the shielding member 22, 810.

According to an embodiment, the shielding member 22, 810 may be a braided shield or a spiral shield.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed is:

1. A cable assembly, comprising:
a cable including:
a plurality of conductors, and
a shielding member to shield the plurality of conductors, and including a plurality of ground wires connectable to a ground electrode; and
a connector including:
a connecting member through which an end of the cable passes,
wherein the cable is configured so that ground wires of the plurality of ground wires in an end area of the cable in the connecting member cross between conductors of the plurality of conductors.

2. The cable assembly of claim 1, wherein
a length of the shielding member in the connecting member is branched into a plurality of shielding lines, and
each shielding line of the plurality of shielding lines crosses between the conductors of the plurality of conductors.

3. The cable assembly of claim 2, wherein
each shielding line of the plurality of shielding lines includes at least one ground wire of the plurality of ground wires.

4. The cable assembly of claim 1, wherein
free ends of the ground wires of the plurality of ground wires are positioned to contact an outer circumferential surface of the cable.

5. The cable assembly of claim 4, wherein
the free ends of the ground wires of the plurality of ground wires are bonded to the outer circumferential surface of the cable by compression.

6. The cable assembly of claim 1, wherein
in the connecting member, a first ground wire of the plurality of ground wires crosses at least a second ground wire of the plurality of ground wires.

7. The cable assembly of claim 1, wherein
the plurality of ground wires form a net or mesh in the connecting member.

8. The cable assembly of claim 7, wherein
the plurality of ground wires form a plurality of layered nets or meshes in the connecting member.

9. The cable assembly of claim 7, wherein
each conductor of the plurality of conductors penetrates a hole of the mesh or the net formed by the plurality of ground wires.

10. The cable assembly of claim 1, wherein
in the connecting member, the plurality of ground wires separate adjacent conductors of the plurality of conductors.

11. The cable assembly of claim 1, wherein
the plurality of ground wires extend to separate and shield the conductors of the plurality of conductors in the connecting member.

12. The cable assembly of claim 1, wherein
the cable is a high-definition multimedia interface (HDMI) cable, and the connector is an HDMI connector.

13. The cable assembly of claim 1, wherein
the plurality of ground wires surround each conductor of the plurality of conductors in the connecting member.

14. The cable assembly of claim 1, wherein
the cable includes a sheath surrounding the shielding member.

15. The cable assembly of claim 1, wherein
the shielding member is a braided shield or a spiral shield.
